(19) United States
(12) Patent Application Publication
(10) Pub. No.: US 2020/0165409 A1
(43) Pub. Date: May 28, 2020

(54) METHOD FOR RECOVERING AND TRANSFORMING LIQUID ABS PLASTIC

(71) Applicant: Jerónimo HIDALGO NAVAS, Priego de Córdoba (ES)

(72) Inventor: Jerónimo HIDALGO NAVAS, Priego de Córdoba (ES)

(21) Appl. No.: 16/632,309

(22) PCT Filed: Mar. 27, 2018
(86) PCT No.: PCT/ES2018/000036

§ 371 Date: Jan. 17, 2020

(30) Foreign Application Priority Data
Jul. 17, 2017 (ES) P 201700665

(51) Int. Cl. C08J 11/22

(52) U.S. Cl. CPC C08J 11/22; C08J 2355/02

(57) ABSTRACT

The invention relates to a method comprising the following steps: first, mixing ground ABS and acetone, the latter varying according to the desired viscosity; second, beating the mixture; third, leaving the mixture to rest in a sealed environment; and fourth, beating the mixture again until same is homogeneous, and leaving to rest for 24 hours.

### FIELD OF THE INVENTION

The present invention relates to the recovery and treatment of ABS (Acrylonitrile Butadiene Styrene), for reuse as liquid plastic to isolate, repair, model or inject onto products and surfaces.

### OBJECT OF THE INVENTION

Acrylonitrile butadiene styrene or ABS is a very impact resistant plastic widely used in automotive and other industrial and domestic uses. It is an amorphous thermoplastic. It is called engineering plastic, because it is a plastic whose processing and processing is more complex than common plastics, such as polyolefins (polyethylene, polypropylene).

Although they are very difficult to process, there are reagents that are achieved with acetone or propanone, a chemical compound of formula CH3 (CO) CH3 from the group of ketones that is naturally found in the environment. At room temperature it is presented as a colorless liquid with a characteristic odor. It evaporates easily, is flammable and is soluble in water. Synthetic acetone is used in the manufacture of plastics, fibers, medications and other chemicals, as well as solvent of other chemicals. With this in mind, anyone can know how to make liquid plastic, but so far no one has patented this formula or managed to give homogeneity to the dough to get diluted to the point of being able to use it for insulation as if it were paint.

The advantages of this invention are the following:

A specific method is offered on the elaboration of the final product of liquid ABS, both for insulation, repair and modeling and for printing.

As it is a method of recovery and waste treatment, the environmental impact caused by the tons of waste produced by the accumulated ABS products for disposal is reduced.

The final product offers solution to many of the everyday problems, from arrangement of objects, insulations to water current, and electrical parts »etc., regardless of whether the surface is smooth or rough.

The industrial application of this invention is within the transformation and processing of ABS liquid plastic, and more specifically transformation and processing from the recovery of waste of said material

### BACKGROUND OF THE INVENTION

Although no invention identical to that described has been found, we present below the documents found that reflect the state of the art related to it.

Thus, document EP2252440A1 refers to a process for injection molding of synthetic material, in particular thermoplastic, in which the starting plastic material to be treated, in particular present in the form of polymer particles or flakes in fragmented or shaped state of particles, it is first subjected to a pretreatment or processing, the plastic material is heated and softened in at least one cutting compressor that operates continuously under constant mixing or movement and, if necessary, a crushing at a temperature by below the melting temperature, preferably above the glass transition temperature, of the plastic material, at least one crushing mixing tool is used for mixing and heating the plastic material, with working edges acting on the material crushing and/or mixing it, thus getting the pretreated and softened, but still fragmented, matte Plastic material directly and immediately and without intermediate phase to a screw injection molding device that operates discontinuously, connected to the direct-cut compressor and immediately and that has an endless screw, which rotates inside a housing and can move within it axially or act as a piston, where it is plasticized and injected to generate a molded part, for example a preform, characterized in that the plastic material is inserted under pressure in the inlet area of the molding device by screw injection by force-feeding due to the movement of the mixing or crushing tool. The method described by the aforementioned invention does not imply the treatment and recycling of solid ABS wastes as the main invention does.

ES2550691T3 describes a method for manufacturing a container, which comprises the steps of making a mixture of a plastic material with additives incorporated therein; injection molding a preform comprising at least one layer made of said mixture, followed by blowing said preform into a container, wherein said additives are made of a material having a higher glass temperature Tg than said plastic material, thereby producing an increase in the value of the temperature Tg, which further comprises the steps of: a core former or grain former in said plastic material, a crystal inside and nuclei in said preform by said last addition. The method described by said invention does not contemplate the treatment and recycling of solid ABS wastes as if the main invention does.

EP0692009A1 proposes a process for treating used plastic or waste materials in order to recover the chemical raw material and liquid fuel components by depolymerizing the material used, which is transformed into a pumping phase and a volatile phase. volatile is separated into a gaseous phase and a condensed or condensable depolymerization product, which is refined by the usual standard processes, the pumping phase that remains once the volatile phase has been separated is subjected to liquid phase hydrogenation, gasification, Low temperature carbonization or a combination of the indicated processes. The phases described in said process of treatment of used plastic materials is different from that proposed by the main invention described below.

None of the above documents are found to solve the problems posed as the proposed invention does.

### SUMMERY OF THE INVENTION

The recovery and transformation procedure of ABS liquid plastic, object of the present invention, for obtaining 170-190 grams (depending on the desired final viscosity) of final product from conventional 120 g test cans, is constituted by from the following stages:

i. Starting from 110 grams of ABS sting, add 60 grams of acetone. Depending on the final viscosity you want, add acetone of 5 in 5 grams.

ii. Beat the mixture until leaving all the ABS impregnated with acetone.

iii. Let the mixture stand for 5 hours in the closed bottle.

iv. Beat again until leaving a homogeneous mixture, and leave for 24 hours at rest.

In the case where ABS liquid plastic is required for priming, it starts from 108 grams of ABS sting instead of 110 grams, and 35 grams of solvent is also added.

On the other hand, once the bond between the components of the ABS, acrylonitrile, butadiene and styrene is broken, the mixture can be treated with refining and filtering mechanisms for packaging, while some dye can be added to the mixture or dye.

### DESCRIPTION OF A PREFERRED EMBODIMENT

A preferred embodiment of the recovery and transformation procedure of ABS liquid plastic, object of the present invention, for obtaining 170 g of final product from conventional 120 g test cans, is constituted from the following steps:

i. Starting from 110 grams of ABS sting, add 60 grams of acetone.

ii. Beat the mixture until all the ABS is impregnated with acetone.

iii. Let the mixture stand for 5 hours in the closed bottle.

iv. Beat again until leaving a homogeneous mixture, and leave for 24 hours at rest.

For the packaging of the final product, the refining and filtering phases are performed, once the acrylonitrile, butadiene and styrene bonds have been broken due to acetone.

1. A method for recovering and converting acrylonitrile butadiene styrene (ABS) liquid plastic, the method comprising:
starting from 110 units of ABS, adding 60 units of acetone;
continuing to add acetone in 5 unit increments based on a desired final viscosity;
mixing until all of the ABS is impregnated by the acetone;
allowing the mixture to stand for 5 hours in a closed container;
then mixing again to obtain a homogeneous mixture; and
allowing the mixture to stand for 24 hours.

2. (canceled)

3. The method according to claim 1, wherein, after the bond between the components of the ABS, acrylonitrile, butadiene and styrene, is broken, the mixture is treated with refining and filtering mechanisms for packaging.

4. The method according to claim 3, further comprising adding dye to the mixture after the bond is broken.

5. The method according to claim 1, wherein:
the units are grams;
the 110 grams of ABS is obtained from a conventional 120 gram can; and
the method yields the homogenous mixture in an amount between 170 grams and 190 grams.

6. A method for recovering and converting acrylonitrile butadiene styrene (ABS) liquid plastic, the method comprising:
starting from 108 units of ABS, adding 60 units of acetone;
continuing to add acetone in 5 unit increments based on a desired final viscosity;
mixing until all of the ABS is impregnated by the acetone;
allowing the mixture to stand for 5 hours in a closed container;
then mixing again to obtain a homogeneous mixture; and
allowing the mixture to stand for 24 hours.

7. The method according to claim 6, wherein:
the units are grams;
the 108 grams of ABS is obtained from a conventional 120 gram can; and
the method yields the homogenous mixture in an amount between 170 grams and 190 grams.

8. The method according to claim 6, wherein, after the bond between the components of the ABS, acrylonitrile, butadiene and styrene, is broken, the mixture is treated with refining and filtering mechanisms for packaging.

9. The method according to claim 8, further comprising adding dye to the mixture after the bond is broken.
